(19) United States
(12) Patent Application Publication
(10) Pub. No.: US 2003/0009649 A1
(43) Pub. Date: Jan. 9, 2003

(54) Dynamic conversion of spreadsheet formulas to multidimensional calculation rules

(76) Inventors: Paul Martin, Fryerning (GB); William Angold, Surrey (GB); Nicolaas Kichenbrand, Surrey (GB)

Correspondence Address: ERIC L. PRAHL, Fish & Richardson P.C., 225 Franklin Street, Boston, MA, 02110-2804, US

(21) Appl. No.: 09/886,938

(22) Filed: Jun. 21, 2001

Related U.S. Application Data
(60) Provisional application No. 60/294,343, filed on May 30, 2001.

(51) Int. Cl. G06F 15/00

(52) U.S. Cl. 712/1

(57) ABSTRACT

A computer-based method for extracting multi-dimensional data from a spreadsheet is disclosed. The method includes a spreadsheet application that has a language for spreadsheet expressions describing calculation relationships among data entities in the spreadsheet application. The method also includes steps for providing a multi-dimensional data storage that has a n-cube (or “cube”) data definition language; providing a spreadsheet in the spreadsheet application that contains a plurality of spreadsheet expressions; parsing the plurality of spreadsheet expressions; and transforming the set of spreadsheet expressions into a set of cube expressions for defining a set of cube entities, which include dimensions. The cube expressions conform to the cube data definition language, and each spreadsheet expression corresponds to a cube expression. The calculation relationships among data entities in the spreadsheet application are transformed into corresponding calculation relationships among the cube entities. The method further includes causing the set of spreadsheet expressions to create the corresponding calculation relationships within the cube.

### TECHNICAL FIELD

This invention relates to computer information systems, and more particularly to spreadsheet applications and multi-dimensional databases.

### BACKGROUND

Spreadsheet applications display data in sheets having rows and columns. Spreadsheet applications are a useful tool for viewing and editing tabular data, i.e. data that fits into rows and columns. For example, as of the writing of this application, the most popular spreadsheet application on the market is Microsoft® Excel (“Excel”), sold by Microsoft Corporation of Redmond, Wash., USA. Excel is one of the top-selling pieces of software of any description. Many computer users are familiar with its tools and techniques.

Many types of information that have simple repeated data structures can be represented in a table, and therefore in a spreadsheet application. For instance, spreadsheet columns may represent the repeated elements of the data structure (sometimes known as “fields”) while rows represent each instance of the information structure, or “record.” Other orientations are possible, too. For example, a carpenter might keep his lumber inventory in a spreadsheet using columns for linear measures such as height, width, and length. Additional information might include the grade of the lumber, where grade is chosen from a short list of possible values, plus an integer value for quantity on hand. The first row would label each column, while subsequent rows would represent the inventory of each group of lumber. For simple inventory purposes, this might be sufficient to the carpenter's needs.

However, some information is more usefully represented in multi-dimensional form. Suppose the carpenter also wanted information about the wood itself, categorizing softwoods such as balsa and pine as well as hardwoods like maple and oak. This categorization is known as a dimension. A dimension may contain, as in this example, hierarchies. This particular hierarchy works as follows: at a first level, it can consider softwood versus hardwood; at a second level, it can consider the particular tree; and, there could be subsequent levels, such as dividing pine into white pine and yellow pine. Information that is dimensional in this way is unwieldy for a spreadsheet to store. By contrast, multi-dimensional databases have been designed specifically for this purpose.

Multi-dimensional databases allow a user to view dimensional data at each of its levels and across multiple dimensions. In the process, there is usually a numeric “measure” dimension being aggregated; the type of wood in the lumber inventory, for example, is of little use for inventory purposes unless it can be compared to the quantity on hand. Thus, a multi-dimensional database might have a dimension for wood type and a measure for quantity. This is why the databases are called multi-dimensional: multiple independent dimensions may be defined over the data. A collection of n dimensions and measures (as data structures) together with the information inside the structures is called a “n-cube,” or “cube” for short.

Often, a cube includes a time-based dimension. Time can be hierarchically represented using levels that contain, for instance, year, quarter, and month. Suppose the carpenter wanted to track the date each piece of wood was milled, so that particularly well-aged pieces could be set aside for fine cabinetry. A multi-dimensional database could support a view of his data showing the quantity of his hardwoods grouped by year; another view into the same data set might show only maple, and aggregate the quantity by month. These sorts of view are “slices” of the cube. A slice is defined by holding a member (or set of members) constant and letting the rest of the cube's dimensions and members vary.

The ability to choose slices for various perspectives on data is one reason multi-dimensional databases can process information in useful ways not available to tabular-data engines. However, the software available for accessing multi-dimensional databases has, to date, not achieved the widespread use that spreadsheet applications have achieved.

An example of a multi-dimensional database product is Microsoft® SQL Server™ 2000 Analysis Services (“Analysis Services”), also a product of Microsoft Corporation of Redmond, Wash., USA. The syntax for definition and manipulation of multi-dimensional objects and data in Analysis Services is known as “MDX,” an acronym for Multidimensional Expressions. Other vendors such as Oracle Corp., of Redwood Shores, Calif., USA, sell comparable products.

Following are some additional concepts and terminology for multi-dimensional databases.

A multi-dimensional database usually has a data-definition language, or DDL, which includes commands for configuring data structures in the database. For a multi-dimensional database, for instance, the DDL can be used to create, delete, and modify cubes and cube elements. MDX can act as a DDL for Analysis Services.

A member is an element within a dimension. A member belongs to exactly one dimension; it also belongs to exactly one of the dimension's levels; and by the nature of hierarchies, any member below the first level belongs to one member on each level above it in the hierarchy. A member can be written in the following notation if its name is unique among the members of its dimension:

[Dimension name].[Member name]

In general, a member can be written as:

[Dimension name].[Hierarchy name].[Level name].[Member name]

Some multi-dimensional databases, for example Analysis Services, support calculated members, defined using calculation rules. The calculation rules may draw upon values from multiple dimensions. For example, in the lumber inventory cube, suppose the measures include “quantity on hand” and “quantity committed to projects.” A calculated member might be “quantity available,” defined as the quantity on hand less the quantity committed to projects. MDX includes features for defining a calculated member's formula.

By holding a member (or set of members) constant and letting the rest of the cube's dimensions and members vary, one can look at a “slice” of the cube data. A slice will usually contain a series of measure values. A slice is a view of the cube that contains one member for each background dimension plus all selected members for all row and column dimensions. A “tuple” is a collection of members. The notation for tuples is a comma-separated list, enclosed in parentheses. A tuple defines a slice; conversely, if you list the members held constant by a slice, a slice defines a tuple. Thus, the two are closely related. “Tuple” usually refers to the expression, while “slice” usually refers to the associated data.

A “cube cell” as we shall use the term is a slice that has at least one member specified for every available dimension (except the measures—the cube cell has a value for each measure). An “intersect” of a cube has at least one member specified for every available dimension, and also has exactly one specified member of a measure. Thus, an intersect is a cube cell that has one measure member specified.

A “parent cell” is a cell that, in at least one of its dimensions, is not at the lowest possible level. That is, one of its members has children beneath it in at least one hierarchy. A “calculated cell” is a cell whose value is based on a formula and derives its measure values, via the formula, from the measures of others. Thus, a calculated cell is not unlike a formula cell in a spreadsheet. The formula may cause the values of a calculated cell to depend on several other cells or slices.

### SUMMARY

In general, in one aspect, the invention is a computer-based method for extracting multi-dimensional data from a spreadsheet. The method includes providing a multi-dimensional data storage that has a cube data definition language, and providing the spreadsheet in a spreadsheet application that has a language for spreadsheet expressions. The spreadsheet expressions describe calculation relationships among data entities in the spreadsheet application. The spreadsheet contains a plurality of spreadsheet expressions that the method parses. The method includes transforming the set of spreadsheet expressions into a set of cube expressions for defining a set of cube entities, which include dimensions. The cube expressions conform to the cube data definition language. The transforming is such that each spreadsheet expression corresponds to a cube expression, and the calculation relationships among data entities in the spreadsheet application are transformed into corresponding calculation relationships among the cube entities. The method further includes causing the set of spreadsheet expressions to create the corresponding calculation relationships within the multi-dimensional data storage.

Preferred embodiments include one or more of the following features. The parsing step includes parsing the plurality of spreadsheet calculation expressions into a set of spreadsheet fact expressions and a set of spreadsheet derivative expressions, while the transforming step includes transforming the set of spreadsheet fact expressions into a set of cube fact expressions defining a set of cube fact entities. The cube fact expressions are expressions within the cube data definition language, such that each spreadsheet fact expression corresponds to a cube fact expression. The transforming step further includes transforming the set of spreadsheet derivative expressions into a set of cube derivative expressions defining a set of cube derivative entities, where the cube derivative expressions are expressions within the cube data definition language. The submitting step includes submitting the set of spreadsheet fact expressions to the multi-dimensional data storage to create the set of cube fact entities, and submitting the set of spreadsheet derivative expressions to the multi-dimensional data storage to create the set of cube derivative entities.

Also in preferred embodiments, the method includes a step for moving data from the spreadsheet fact expressions into the corresponding cube fact entities, using the correspondence defined during the step of transforming the set of spreadsheet fact expressions. Also, the multi-dimensional data storage includes a set of cube fact entities, and the parsing step includes parsing the plurality of spreadsheet calculation expressions into a set of spreadsheet fact expressions and a set of spreadsheet derivative expressions, where the set of spreadsheet derivative expressions is possibly empty. Furthermore, the transforming step includes transforming the set of spreadsheet derivative expressions into a set of cube derivative expressions defining a set of cube derivative entities, where the cube derivative expressions are expressions within the cube data definition language. The submitting includes submitting the set of spreadsheet derivative expressions to the multi-dimensional data storage to create the set of cube derivative entities.

Still more features include the following. The transforming step consolidating the set of cube expressions into a consolidated set of cube expressions having equivalent collective scope, equivalent calculation behavior, and fewer expressions than the set of cube expressions contained before the consolidating. An interactive dialog wizard provides at least part of the user's interaction with the method. The method is implemented as an add-in to a spreadsheet application

In general, in another aspect, the invention is a computer apparatus for extracting multi-dimensional data from a spreadsheet. The apparatus includes a central processing unit, random-access memory, a storage device, and devices for user input and output interconnected by a bus, together with computer-readable instructions. The instructions are capable of causing the processing unit to perform the steps of: providing a multi-dimensional data storage that has a cube data definition language, and providing the spreadsheet in a spreadsheet application that has a language for spreadsheet expressions. The spreadsheet expressions describe calculation relationships among data entities in the spreadsheet application. The spreadsheet contains a plurality of spreadsheet expressions. The method further includes parsing the plurality of spreadsheet expressions, and transforming the set of spreadsheet expressions into a set of cube expressions for defining a set of cube entities. The cube entities include dimensions, and the cube expressions conform to the cube data definition language. Each spreadsheet expression corresponds to a cube expression. The calculation relationships among data entities in the spreadsheet application are transformed into corresponding calculation relationships among the cube entities. The method further includes causing the set of spreadsheet expressions to create the corresponding calculation relationships within the multi-dimensional data storage, and moving fact data from the spreadsheet expressions into the corresponding cube entities, where the moving uses the correspondence defined during the transforming step.

The invention makes it possible to move data and calculations, initially provided in a spreadsheet-compatible format, into a cube. The cube may provide views, operations, optimized response times to certain queries, or other information processing features that were not available to the user before the move.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a spreadsheet application with processes for multi-dimensional data extraction and editing.

FIG. 1B is a block diagram of a computing platform for a spreadsheet application.

FIG. 1C is a block diagram of a spreadsheet application with a wizard process.

FIG. 1D is a block diagram of a spreadsheet application with an add-in facility.

FIG. 2 is a flowchart of an extraction process.

FIG. 3 is a flowchart of a setup process.

FIG. 4 is a flowchart of a rule extractor process.

FIG. 5 is a flowchart of a scanner process.

FIG. 6 is a flowchart of a consolidator process.

FIG. 7 is a flowchart of a left-hand side consolidator function.

FIG. 8A shows an example spreadsheet.

FIG. 8B shows an example spreadsheet with cell contents replaced by captions.

FIG. 9 is a block diagram of example multi-dimensional data structures.

Like reference symbols in the various drawings indicate like elements.

### DETAILED DESCRIPTION

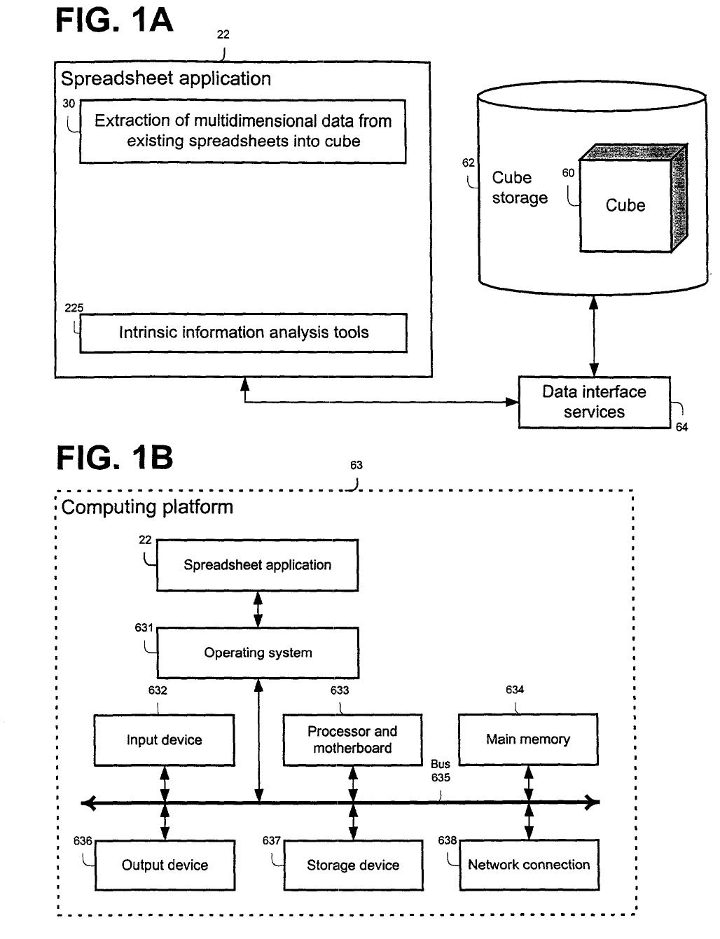

In one embodiment, with reference to FIG. 1A, a spreadsheet application 22 has an extraction process 30 for extracting multidimensional data into a cube 60. The spreadsheet application 22 is implemented in software running on a computing platform 63, shown in FIG. 1B.

Overview

As will be described in more detail below, a user, not shown, can apply the extraction process 30 to spreadsheet-based calculations in order to configure the cube 60. This enables the user to move information structures and (optionally) the information itself from a spreadsheet into a cube.

An advantage of the described embodiment is that the user can use the spreadsheet application 22 as an information-analyzing environment for information in the cube 60. This can be especially useful when the user is already familiar with the use of intrinsic information analysis tools 225 in the spreadsheet application 22. Intrinsic information analysis tools 225 may include features for formatting and exporting information as well as analytical tools such as what-if scenarios, problem solving, numeric calculations, and other features known to those skilled in the art. The range of tools intrinsic to the spreadsheet application 22 is not central to the described invention and will not be described exhaustively here; the tools 225 are cited, among other reasons, to show a benefit to using a spreadsheet application 22 with respect to multi-dimensional data access.

Another benefit to using a cube 60 is that the cube 60 may include features that were not intrinsically available from within the spreadsheet application 22, such as the ability to view a slice that intersects the dimensional hierarchies of the cube 60 at various levels. Also, the engine of a multi-dimensional database will often pre-compute the aggregations on its measures, providing significantly improved response times (as compared with queries that are not pre-computed).

Additional benefits can occur when the data is initially provided in a spreadsheet-compatible format but would be more useful in the cube 60, or in any case when the user considers the spreadsheet application 22 to be their tool-of-choice for information analysis.

Computing Environment

FIG. 1A shows a spreadsheet application 22 that can access a cube storage 62 via data interface services 64. In the present embodiment, the spreadsheet application 22 is Excel. The data interface services 64 includes ADO (Active Data Objects) and DAO (Data Access Objects) implementations such as those provided by Microsoft. The data interface services 64 may also include ProClarity connectivity. ProClarity is manufactured by ProClarity Corporation, Inc. Using ADO, DAO, and ProClarity to provide data services to software applications is well known in the art.

In the present embodiment, the cube storage 62 may include software for database and other data storage services, such as Microsoft® Access 2000 and the Microsoft Jet database engine, or Microsoft® SQL Server™ 2000, all of which are products of Microsoft Corp. The cube storage 62 supports a DML (data manipulation language) appropriate to the data storage software, such as MDX (Multidimensional Expressions) for Microsoft SQL Server 2000 Analysis Services. The cube storage 62 may be a database or a combination of databases. The cube storage 62 includes a cube 60 that can act as a multidimensional data source. The cube 60 contains structures for data and can also contain the data itself. The cube 60 may have as few as one dimension or as many dimensions as its storage devices and underlying software will support. (In an unconfigured state, the cube 60 has no dimensions.) The spreadsheet application 22 has access to a variety of services and devices, shown in FIG. 1B. The spreadsheet application 22 runs on a computing platform 63 that includes an operating system 631 such as Microsoft Windows 98. The operating system 631 is a software process, or set of computer instructions, resident in either main memory 634 or a storage device 637 or both.

A processor and motherboard 633 contains at least one processor that can access main memory 634 to execute the computer instructions that describe the operating system 631 and the spreadsheet application 22.

The user interacts with the computing platform via an input device 632 and an output device 636. For Windows 98, possible input devices 632 include a keyboard, a microphone, a touch-sensitive screen and a pointing device such as a mouse; possible output devices 636 include a display screen, a speaker, and a printer.

The storage device 637 includes a computer-writable and computer-readable medium, such as a disk drive. A bus 635 interconnects the processor and motherboard 633, the input device 632, the output device 636, the storage device 637, main memory 634, and optional network connection 638. The network connection 638 includes a device and software driver to provide network functionality, such as an Ethernet card configured to run TCP/IP, for example.

As is known in the art, when a network connection 638 is present and connected to a network with other hosts, not shown, the cube storage 62 need not be hosted on the same computing platform as the spreadsheet application 22. That is, cube storage 62 may be available remote via a network connection 638. For instance, the data interface services 64 may perform data remoting services transparently to the spreadsheet application 22, as is well known in the art. For the sake of simplicity, however, the description of the present embodiment will refer to cube storage 62 as though it were local to the spreadsheet application 22.

In the present embodiment, the extraction process 30 is written in the programming environment Microsoft® Visual Basic™, which is another product of Microsoft Corp. Some components may be written in other languages such as C++ or Delphi and incorporated into the main body of software code via component standards such as COM (Common Object Model) or OLE (Object Linking and Embedding), as is known in the art.

Extraction

In one embodiment, an extraction process 30 converts formulas in a Microsoft Excel spreadsheet into MDX calculation statements. The extraction process 30 is a software program or set of computer instructions capable of interacting with the spreadsheet application 22 via interfaces that the spreadsheet exposes, such as OLE or an internal scripting environment like Visual Basic for Applications. The extraction process 30 can configure a cube 60 based on the spreadsheet formulas and can populate the cube 60 with data from the spreadsheet.

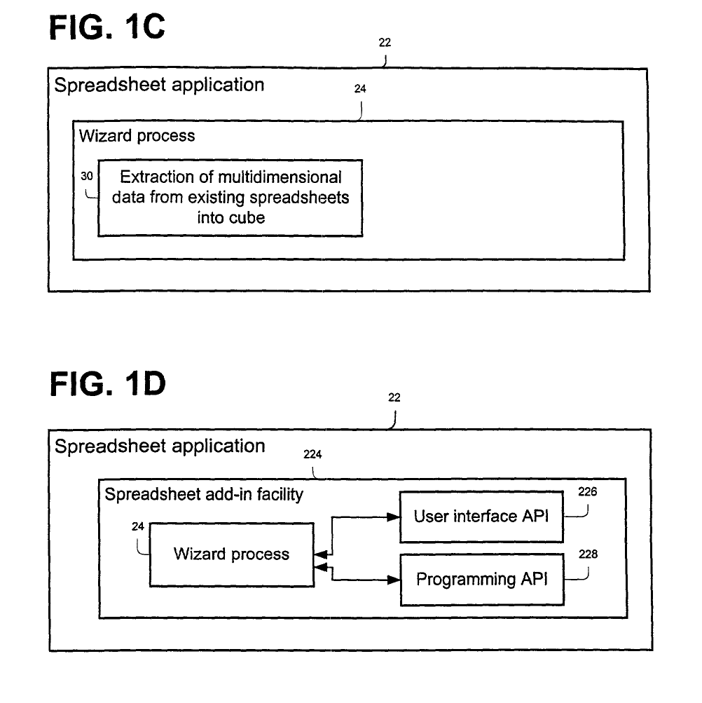

With reference to FIG. 2, the extraction process 30 includes a setup process 32, a rule extractor 34, a structure instantiation process 36, and a migration process 38. The extraction process 30 can use resources including a spreadsheet collection 26, a spreadsheet syntax model 33, and a multi-dimensional syntax model 37. The extraction process 30 may at times access cube storage 62, as will be explained in more detail.

The extraction process 30 invokes the setup process 32 before the rule extractor 34, the rule extractor 34 before the structure instantiation process 36, and the structure instantiation process 36 before the migration process 38.

Extraction Setup

In general, the setup process 32 establishes computing environments and data sources for use by subsequent processes.

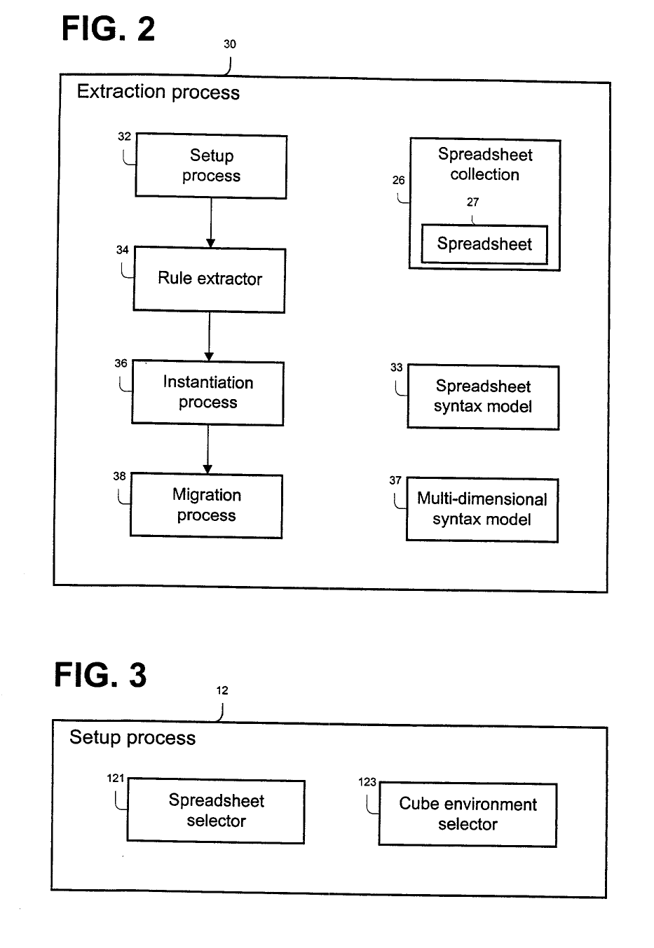

With reference to FIG. 3, the setup process 32 includes a spreadsheet selector 121 and a cube environment selector 123. The spreadsheet selector 121 adds at least one spreadsheet sheet 27 to the spreadsheet collection 26. The spreadsheet sheet 27 and the spreadsheets in the spreadsheet collection 26 are compatible with Excel. The spreadsheet selector 121 may also specify a range within a spreadsheet sheet 27 to which the extraction process 30 will be confined. The range may have portions demarked as metadata, i.e. data that describes other data within the range. Example metadata includes column and row headers.

The cube environment selector 123 specifies a cube 60 and configures connections via data interface services 64. If the cube 60 is not yet configured, the cube environment selector 123 may specify dimensions and members to be added to the cube 60.

The setup process 32 may also map regions of a spreadsheet sheet 27 to elements of the cube 60. For many spreadsheet formats, this may be as simple as mapping metadata values to members and dimensions of the cube 60.

Rule Extractor

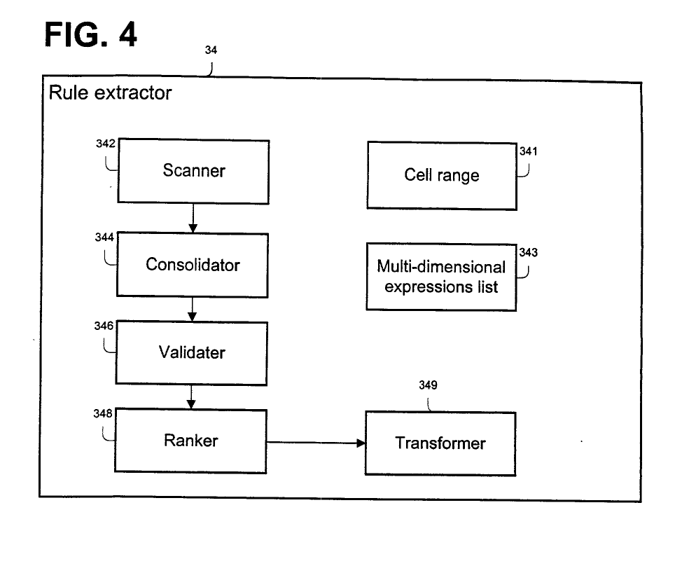

The extraction process 30 invokes the rule extractor 34 after the setup process 32. In general, with reference to FIG. 4, the rule extractor 34 examines the spreadsheet collection 26 for calculations expressed in a syntax (described in a spreadsheet syntax model 33), converts the calculations to expressions appropriate to a multi-dimensional syntax model 37, and normalizes the multi-dimensional calculation expressions by consolidating, validating, and ranking them. One objective of the normalization is to ensure that interdependencies between the multi-dimensional calculation expressions do not cause problems in the multi-dimensional calculation environment. Examples of potential problems include circular references, reference antecedence errors, and unnecessary inefficiencies.

The extraction process 30 also distinguishes spreadsheet cells that contain factual data from spreadsheet cells that contain calculations. This latter category can be called “derivative” values. A derivative cell contains a calculation expression (or a reference to a calcuation expression) that computes its value based on the values of other cells or functions.

The rule extractor 34 includes a scanner 342, a consolidator 344, a validater 346, a ranker 348, and a transformer 349. In addition, the rule extractor 34 includes a cell range 341 and a multi-dimensional expressions list 343.

The rule extractor 34 invokes the scanner 342 before invoking the consolidator 344, the consolidator 344 before the validater 346, and the validater 346 before the ranker 348.

Scanner

The scanner 342 examines the spreadsheet collection 26 for information to extract. Information relevant to the scanner 342 includes calculations used within a spreadsheet and entities used as inputs and outputs of such calculations. The scanner 342 identifies instances of this information and makes it available for use by subsequent processes.

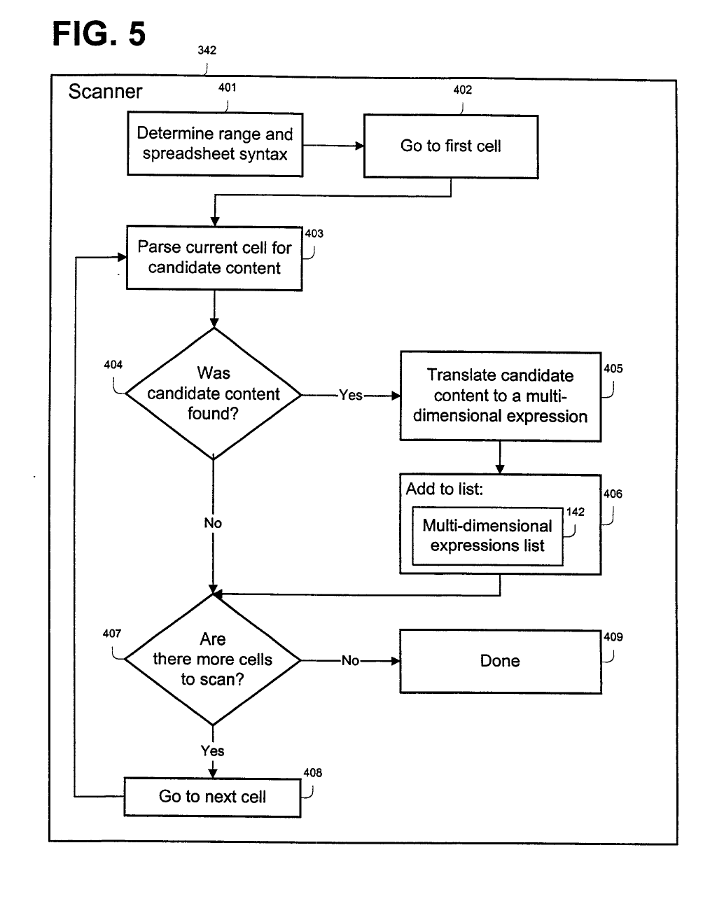

With reference to FIG. 5, the scanner 342 determines a range to scan and a spreadsheet syntax to use (step 401). Specifically, the scanner 342 receives a reference to a spreadsheet syntax model 33 (step 401). The spreadsheet syntax model 33 will be used to examine the contents of cells in the spreadsheets in the spreadsheet collection 26. With Excel, the spreadsheet syntax model 33 models the syntax of the formulas that can be entered into cells. One use of the spreadsheet syntax model 33 is to identify operations such as “SUM” and “AVERAGE” that have counterparts within the operations applicable to the cube 60, so that the spreadsheet expressions can be mapped to the cube expressions.

The scanner 342 also receives a reference to a cell range 341 (also in step 401). The cell range 341 specifies which cells in the spreadsheets in the spreadsheet collection 26 are to be examined by the scanner 342.

The scanner 342 begins at a first cell in the cell range 341 (step 402). The scanner 342 parses the current cell for candidate content (step 403). Candidate content includes calculations expressed in the spreadsheet syntax described in the spreadsheet syntax model 33 determined in step 401. These calculations may include functions, variables, literals, cell references, operators, and special tokens. When the spreadsheet is Excel, examples of special tokens include brackets, colons, and exclamation marks.

The scanner 342 evaluates whether the current cell contains candidate content (step 404). If candidate content is present (step 404), the scanner 342 translates the candidate content into a multi-dimensional calculation expression, fitting the multi-dimensional syntax model 37 (step 405). The scanner 342 then adds the multi-dimensional calculation expression to the multi-dimensional expressions list 343 (step 406). However, if candidate content was not present in step 404, the scanner 342 moves directly to evaluation step 407.

The scanner 342 evaluates whether there are more cells to scan (step 407). If there are, the scanner 342 goes to the next cell in the range of cells (step 408) and another parsing begins (step 403); otherwise, the scanner 342 halts (step 409).

Consolidator

In general, the consolidator 344 tries to eliminate unnecessary repetitions inside the multi-dimensional expressions list 343. The consolidator 344 checks the syntax of these expressions for opportunities to combine and thereby simplify them. Broadly speaking, if the multi-dimensional expressions list 343 contains a set of expressions which specify a rule with particularity over every possible element of a dimension, this is unnecessary detail; it should be possible to express the rule once, with generality, to cover the particular cases at the wider scope of the entire dimension. Likewise, with hierarchical dimensions, there can be similar opportunities for consolidation, if not to the scope of the entire dimension, perhaps within the scope of a higher level in the hierarchy. The consolidator 344 operates on the multi-dimensional expressions list 343 to try to replace exhaustive, narrowly-scoped expressions with fewer, broadly-scoped expressions whose behavior will be functionally equivalent.

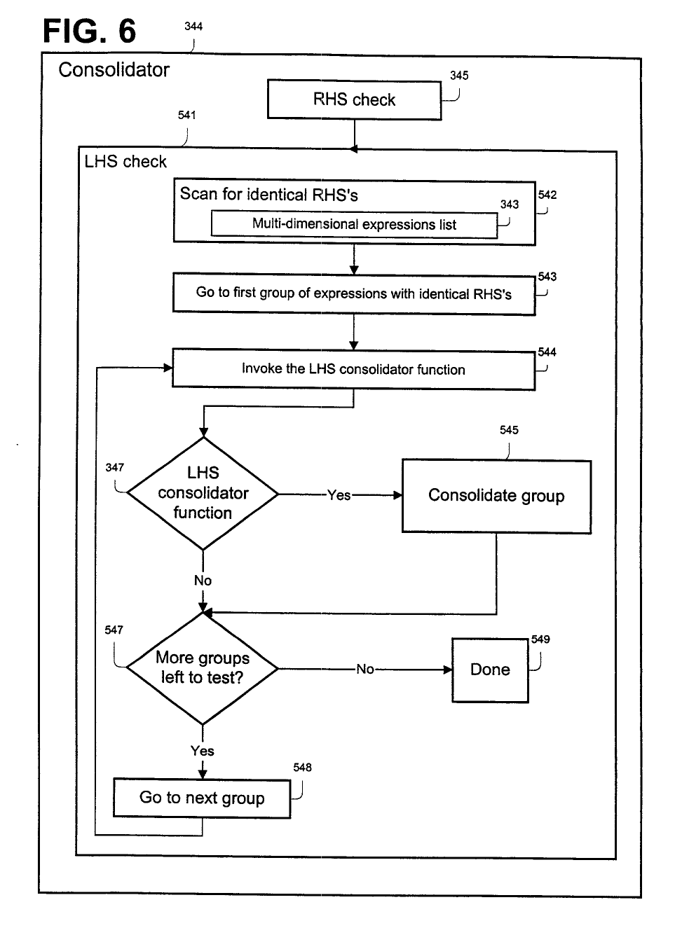

With reference to FIG. 6, the consolidator 344 includes subroutines for a right-hand side (RHS) check 52 and a left-hand side (LHS) check 54. The consolidator 344 invokes the RHS check 345 before the LHS check 541.

The RHS check 345 tries to eliminate right-hand-side repetitions. The RHS check 345 checks each expression in the multi-dimensional expressions list 343. The RHS check 345 tests the right-hand side of the expression to see if any dimension member is common to every component on that side. If a common member is found, it is eliminated from the RHS of the expression. As an example using MDX, consider the following calculation rule:

SALES.TOTAL=SALES.NORTH+SALES.SOUTH

RHS check 345 finds the dimension member SALES to be common to all components, so RHS check 345 eliminates it from the right hand side, leaving:

SALES.TOTAL=NORTH+SOUTH

The RHS check 345 runs to completion before the LHS check 541 is begun.

The LHS check 541 normalizes expressions in the multi-dimensional expressions list 343 based on LHS properties of the multi-dimensional expressions. Specifically, LHS check 541 scans the multi-dimensional expressions list 343 for expressions having identical RHS's. For each such group of expressions having identical RHS's, the LHS check 541 uses the LHS consolidator function 347 to test whether to consolidate the group into a single expression. The LHS may be applied to the multi-dimensional expressions list 343 repeatedly, until no more consolidations occur.

First, the LHS check 541 scans the multi-dimensional expressions list 343 for expressions having identical right-hand sides (step 542).

Then, LHS check 541 examines the first such group (step 543).

Next, the LHS check 541 invokes the LHS consolidator function 347 (step 544). If the LHS consolidator function 347 so indicates, the LHS check 541 consolidates the group into a single expression (step 545); otherwise, the LHS check 541 goes on to test whether there is another group of expressions having identical RHS's left to test (step 547). A positive test leads the LHS check 541 to the next such RHS group (step 548) and another examination begins (step 543); otherwise, the LHS check 541 halts (step 549).

LHS Consolidator Function

The LHS consolidator function 347 considers properties of the left hand side of expressions in the multi-dimensional expressions list 343, returning a positive result if it determines the group can be consolidated into a single expression, and returning a negative result otherwise.

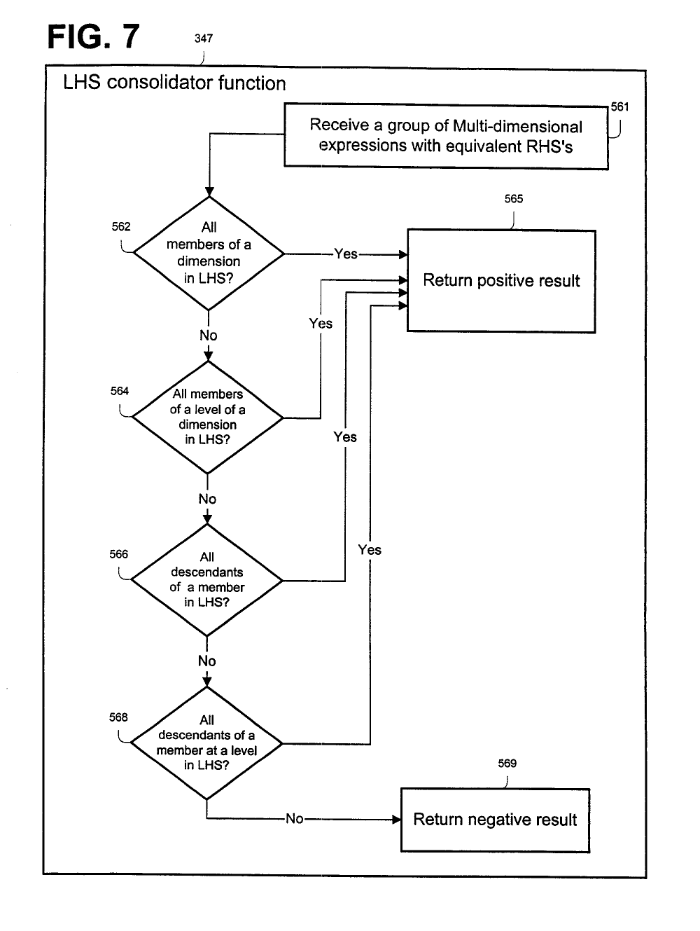

With reference to FIG. 7, the LHS consolidator function 347 receives from step 544 a group of multi-dimensional expressions having identical RHS's (step 561). The LHS consolidator function 347 then performs up to four tests; if any is positive, the function 56 returns a positive result (step 565). Otherwise, the function is negative (step 569).

First, the LHS consolidator function 347 tests whether all members of a dimension are quoted on the left hand side of the equation (a rule per member) (step 562).

Second, the LHS consolidator function 347 tests whether all members of a level of a dimension are quoted on the left hand side of the equation (a rule per member) (step 564).

Third, the LHS consolidator function 347 tests whether all descendants of a member are quoted on the left hand side of the equation (one rule per member) (step 566).

Fourth, the LHS consolidator function 347 tests whether all descendants of a member at a level are quoted on the left hand side of the equation (one rule per member) (step 568).

As an example, suppose again that the multi-dimensional syntax model 37 contains a syntax for MDX. Consider two expressions:

SALES.TOTAL=NORTH+SOUTH

COST.TOTAL=NORTH+SOUTH

The right hand side of the expression is the same in both rules. If SALES and COST match any of the criteria specified above then the two rules are reduced into one:

TOTAL=NORTH+SOUTH

If SALES and COST do not match the criteria then the two rules remain as separate rules.

In another embodiment, steps 562, 564, 566, and 568 may be performed in a different sequence (not shown).

Validater

The validater 346 ensures that all expressions in the multi-dimensional expressions list 343 contain the same dimensions on both sides of the expression. If the validater 346 detects an error, the relevant expression is ignored and highlighted.

One feature of the validater 346 is that it detects whether the spreadsheet collection 26 is poorly configured. When the calculation expressions are well structured and complete, the resulting multi-dimensional expressions list 343 will always pass this test. One advantage of performing this test before attempting to configure the cube 60 is that the extraction process 30 can warn the user and allow the user to correct the problem.

Ranker

The ranker 348 attempts to ensure the calculations represented by the expressions in the multi-dimensional expressions list 343 will be performed in the right sequence, i.e. a calculated value required by a second expression must be calculated before the second expression. The ranker 348 works out the depth of each expression in the multi-dimensional expressions list 343 by a recursive process, selecting each member of the right hand side of the equation in turn and checking for its existence on the left hand side of each of the other (n −1) expressions. Each time the member is found its depth is increased. The ranker 348 thereby re-organizes the multi-dimensional expressions list 343 with the higher depth values first.

Note that it is possible for circular references to occur in the multi-dimensional expressions list 343 such that no ordering will satisfy all precedence constraints, as in the following example list:

[Sales].[Abrams]=[Sales].[Brown]*0.25

[Sales].[Brown]=[Sales].[Chen]* 0.45

[Sales].[Chen]=[Sales].[Abrams]* 0.33

The ranker 348 detects the existence of circular references within the multi-dimensional expressions list 343 and returns a descriptive error.

Note that the re-ordering of the multi-dimensional expressions list 343 is only necessary if the multidimensional calculation environment (in this embodiment, MDX) processes the multi-dimensional expressions list 343 “procedurally,” i.e., the behavior is dependent on the order in which the expressions are submitted. Though at present MDX does behave procedurally on certain inputs, conceivably this might someday change. For instance, MDX might pre-process expressions differently, or another multidimensional calculation environment might offer the essential functionality of the ranker 348 as an inherent feature of the back-end engine. In that event, the ranker 348 could be an optional process. However, there is still some advantage to detecting error conditions early, so that the user can be informed and allowed to correct the errors without delay.

Instantiation Process

The extraction process 30 may invoke a structure instantiation process 36. The structure instantiation process 36 uses the expressions in the multi-dimensional expressions list 343 to generate statements appropriate to the multi-dimensional syntax model 37. Each such statement creates a calculated cell rule.

With reference to FIG. 13, if the dimensions 61a, 61b, 61c, etc., have not yet been created, the instantiation process 36 may do so.

Migration Process

The extraction process 30 may invoke the migration process 38. The migration process 38 moves fact data from the spreadsheet collection 26 into the cube 60. Fact data, in this context, is the value of any spreadsheet cell that maps to an intersect of the cube 60.

The migration process 38 must determine, for each piece of fact data to be moved, where to store it within the cube 60. Then it is a straightforward matter to issue a series of commands to the cube 60 via the data interface services 64 to migrate the data. The fact data must be associated with a measure. The user could specify this information for every piece of data, although that approach can be laborious. An approach less burdensome to the user is to submit the spreadsheet collection 26 in a format that allows the migration process 38 to infer each piece of data's dimensional membership based on its position within the spreadsheet. For instance, if the data is presented in rows and columns within a demarked area of the spreadsheet, and the leftmost columns and topmost rows of the demarked area contain labels that can be mapped to dimensions of the cube 60, all the user need specify is the relationship between the labels and the dimensions. These topmost rows are column headings, and the leftmost columns are row headings. It is then straightforward to correlate the pieces of data to the headings on the rows and columns in which they lie. The user need only provide the relation between the headings and the dimensions of the cube 60, and even this step can be automated if the labels can be mapped, via a formula, to the names of cube dimensions.

Extraction Process Example

It may be helpful to step through an example of the extraction process 30 in action. For clarity of explanation, we have chosen a straightforward example; many practical deployments of the extraction process 30 would be more complex.

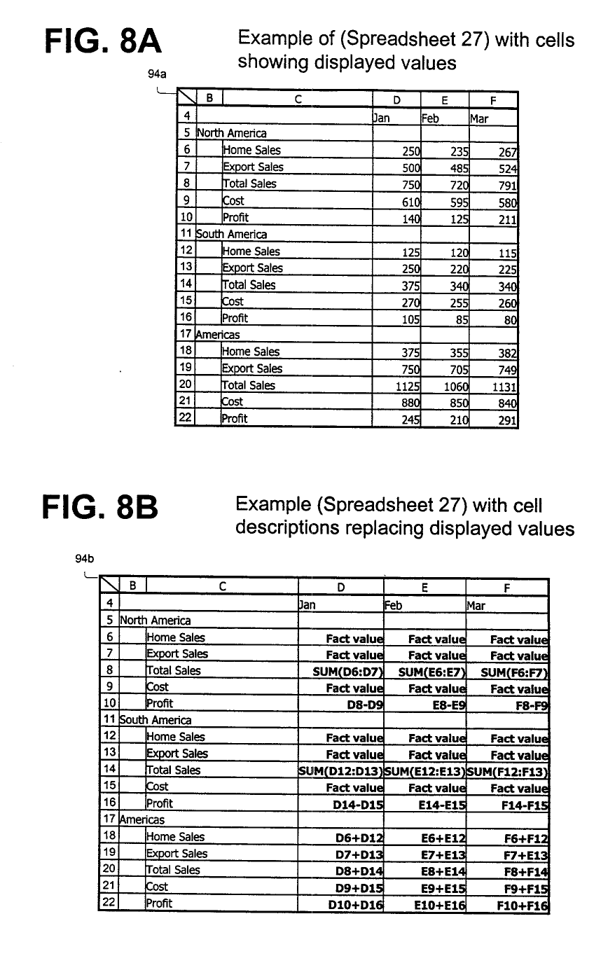

FIG. 8A shows a display spreadsheet 94a, which is a sample such as might belong to the spreadsheet collection 26 after selection by the spreadsheet selector 121 (see FIG. 2). For this example, this will be the only spreadsheet 27 in the spreadsheet collection 26.

Similarly, FIG. 8B shows a captioned spreadsheet 94b, which is a version of the display spreadsheet 94a where the cell display values have been replaced with captions that describe the contents of each cell within the cell range (i.e., not including the column and row headers). For instance, cell D6 shows the display value “250” in the display spreadsheet 94a. This value is captioned “Fact value” in the captioned spreadsheet 94b to indicate that this is a simple data value. In contrast, cell D8 shows the display value “750” in the display spreadsheet 94a, but its caption in the captioned spreadsheet 94b indicates that D8 is not a simple data value but contains a calculation expression. Specifically, cell D8's calculation expression is a derived value, being the sum of the values in the cell range between cells D6 and D7.

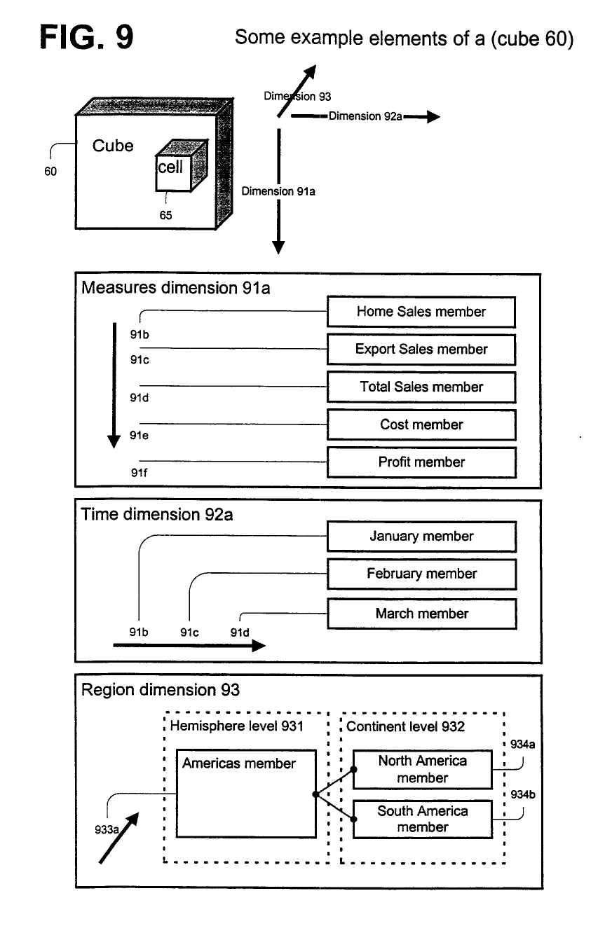

In the display spreadsheet 94a, the range of cells selected by the spreadsheet selector 121 goes from B4 to F22, where row 4 and columns B and C are demarked as metadata, and range D5-F22 contains data values. FIG. 9 shows cube elements such as might belong to a cube 60 selected by the cube environment selector 123 for the display spreadsheet 94a.

The scanner 342 analyzes every cell for candidate content—in this case, an Excel-based formula. The scanner 342 produces a multi-dimensional expressions list 343. The sample output of this list is shown in Table 1, with index numbers added to the expressions for clarity. (The index numbers need not appear in the multi-dimensional expressions list 343 itself.)

TABLE 1

| | |
|---|---|
| 1. | ([Measures].[Total Sales], [Time].[Jan], [Region].[North America]) = SUM( |
| | ([Measures].[Home Sales], [Time].[Jan], [Region].[North America]), |
| | ([Measures].[Export Sales], [Time].[Jan], [Region].[North America])) |
| 2. | ([Measures].[Total Sales], [Time].[Feb], [Region].[North America]) = SUM( |
| | ([Measures].[Home Sales], [Time].[Feb], [Region].[North America]), |
| | ([Measures].[Export Sales], [Time].[Feb], [Region].[North America])) |
| 3. | ([Measures].[Total Sales], [Time].[Mar], [Region].[North America]) = SUM( |
| | ([Measures].[Home Sales], [Time].[Mar], [Region].[North America]), |
| | ([Measures].[Export Sales], [Time].[Mar], [Region].[North America])) |
| 4. | ([Measures]. [Profit], [Time].[Jan], [Region].[North America]) = |
| | ([Measures].[Total Sales], [Time].[Jan], [Region].[North America]) − |
| | ([Measures].[Cost], [Time].[Jan], [Region].[North America]) |
| 5. | ([Measures].[Profit], [Time].[Feb], [Region].[North America]) = |
| | ([Measures].[Total Sales], [Time].[Feb], [Region].[North America]) − |
| | ([Measures].[Cost], [Time].[Feb], [Region].[North America]) |
| 6. | ([Measures].[Profit], [Time].[Mar], [Region].[North America]) = |
| | ([Measures].[Total Sales], [Time].[Mar], [Region].[North America]) − |
| | ([Measures].[Cost], [Time].[Mar], [Region].[North America]) |
| 7. | ([Measures][Total Sales], [Time].[Jan], [Region].[South America]) = SUM( |
| | ([Measures]. [Home Sales], [Time].[Jan], [Region].[South America]), |
| | ([Measures].[Export Sales], [Time].[Jan], [Region].[South America])) |
| 8. | ([Measures].[Total Sales], [Time].[Feb], [Region].[South America]) = SUM( |
| | ([Measures].[Home Sales], [Time].[Feb], [Region].[South America]), |
| | ([Measures].[Export Sales], [Time].[Feb], [Region].[South America])) |
| 9. | ([Measures].[Total Sales], [Time].[Mar], [Region].[South America]) = SUM( |
| | ([Measures].[Home Sales], [Time].[Mar], [Region].[South America]), |
| | ([Measures].[Export Sales], [Time].[Mar], [Region].[South America])) |
| 10. | ([Measures].[Profit], [Time].[Jan], [Region].[South America]) = |
| | ([Measures].[Total Sales], [Time].[Jan], [Region].[South America]) − |
| | ([Measures].[Cost], [Time].[Jan], [Region].[South America]) |
| 11. | ([Measures].[Profit], [Time].[Feb], [Region].[South America]) = |
| | ([Measures].[Total Sales], [Time].[Feb], [Region].[South America]) − |
| | ([Measures].[Cost], [Time].[Feb], [Region].[South America]) |
| 12. | ([Measures].[Profit], [Time].[Mar], [Region].[South America]) = |
| | ([Measures].[Total Sales], [Time].[Mar], [Region].[South America]) − |
| | ([Measures].[Cost], [Time].[Mar], [Region].[South America]) |
| 13. | ([Measures].[Home Sales], [Time].[Jan], [Region].[Americas]) = |
| | ([Measures].[Home Sales], [Time].[Jan], [Region].[North America]) + |
| | ([Measures].[Home Sales], [Time].[Jan], [Region].[South America]) |
| 14. | ([Measures].[Home Sales], [Time].[Feb], [Region].[Americas]) = |
| | ([Measures].[Home Sales], [Time].[Feb], [Region].[North America]) + |
| | ([Measures].[Home Sales], [Time].[Feb], [Region].[South America]) |
| 15. | ([Measures].[Home Sales], [Time].[Mar], [Region].[Americas]) = |
| | [Measures].[Home Sales], [Time].[Mar], [Region].[North America]) + |
| | ([Measures].[Home Sales], [Time].[Mar], [Region].[South America]) |
| 16. | ([Measures].[Export Sales], [Time].[Jan], [Region].[Americas]) = |
| | [Measures].[Export Sales], [Time].[Jan], [Region].[North America]) + |
| | ([Measures].[Export Sales], [Time].[Jan], [Region].[South America]) |
| 17. | ([Measures].[Export Sales], [Time].[Feb], [Region].[Americas]) = |
| | [Measures].[Export Sales], [Time].[Feb], [Region].[North America]) + |
| | ([Measures].[Export Sales], [Time].[Feb], [Region].[South America]) |
| 18. | ([Measures].[Export Sales], [Time].[Mar], [Region].[Americas]) = |
| | [Measures].[Export Sales], [Time].[Mar], [Region].[North America]) + |
| | ([Measures].[Export Sales], [Time].[Mar], [Region].[South America]) |
| 19. | ([Measures].[Total Sales], [Time].[Jan], [Region].[Americas]) = |
| | [Measures].[Total Sales], [Time].[Jan], [Region].[North America]) + |
| | ([Measures].[Total Sales], [Time].[Jan], [Region].[South America]) |
| 20. | ([Measures].[Total Sales], [Time].[Feb], [Region].[Americas]) = |
| | [Measures].[Total Sales], [Time].[Feb], [Region].[North America]) + |
| | ([Measures][Total Sales], [Time].[Feb], [Region].[South America]) |
| 21. | ([Measures].[Total Sales], [Time].[Mar], [Region].[Americas]) = |
| | [Measures].[Total Sales], [Time].[Mar], [Region].[North America]) + |
| | ([Measures].[Total Sales], [Time].[Mar], [Region].[South America]) |
| 22. | ([Measures].[Cost], [Time].[Jan], [Region].[Americas]) = |
| | [Measures].[Cost], [Time].[Jan], [Region].[North America]) + |
| | ([Measures].[Cost], [Time].[Jan], [Region].[South America]) |
| 23. | ([Measures].[Cost], [Time].[Feb], [Region].[Americas]) = |
| | [Measures].[Cost], [Time].[Feb], [Region].[North America]) + |
| | ([Measures].[Cost], [Time].[Feb], [Region].[South America]) |
| 24. | ([Measures].[Cost], [Time].[Mar], [Region].[Americas]) = |
| | [Measures].[Cost], [Time].[Mar], [Region].[North America]) + |
| | ([Measures].[Cost], [Time].[Mar], [Region].[South America]) |
| 25. | ([Measures].[Profit], [Time].[Jan], [Region].[Americas]) = |
| | [Measures].[Profit], [Time].[Jan], [Region].[North America]) + |
| | ([Measures].[Profit], [Time].[Jan], [Region].[South America]) |
| 26. | ([Measures].[Profit], [Time].[Feb], [Region].[Americas]) = |
| | [Measures].[Profit], [Time].[Feb], [Region].[North America]) + |
| | ([Measures].[Profit], [Time].[Feb], [Region].[South America]) |
| 27. | ([Measures].[Profit], [Time].[Mar], [Region].[Americas]) = |
| | [Measures].[Profit], [Time].[Mar], [Region].[North America]) + |
| | ([Measures].[Profit], [Time].[Mar], [Region].[South America]) |

Using the example, if the scanner 342 starts with the first data row and moves across each data column, the first cell found to have candidate content is D8. Cell D8 has the formula: “SUM(D6:D7)”. After parsing the formula, the components are: function SUM, and a range of cells from D6 to D7. The list of components generated by the parse algorithm is then converted into MDX format as follows:

SUM=>SUM

D6=>([Measures].[Home Sales], [Time].[Jan], [Region].[North America])

D7=>([Measures].[Export Sales], [Time].[Jan], [Region].[North America])

The MDX formula for ([Measures].[Total Sales], [Time].[Jan], [Region].[North America]) is equal to:

SUM(([Measures].[Home Sales], [Time].[Jan], [Region].[North America]), ([Measures].[Export Sales], [Time].[Jan], [Region].[North America]))

For the display spreadsheet 94a, the scanner 342 converts each cell into a tuple by the following three steps. First, for each dimension in turn, if the dimension is defined in a column, the system looks in the column where the dimension is defined for the row on which the current cell is. If a member is found this member will be used. If a member is not found, the system will start moving up a row at a time in the same column until a member is found.

Second, if the dimension is defined in a row, the system will look on the row where the dimension is defined for the column on which the current cell is. If a member is found this member will be used; otherwise, the system will start moving to the left a column at a time until a member is found.

Third, if no member is found, the cell is ignored.

With regard to cell D6, the first dimension is the Measures dimension 91a, whose members appear in column C. The scanner 342 will check along row 6 to cell C6 and find the caption “Home Sales”, which is associated with the Home Sales member 91b. The second dimension is the Time dimension 92a, whose members appear in row 4. The scanner 342 will check along column D to cell D4 and find “Jan”, which is associated with the January member 92b. Note that while the caption “Home Sales” matched the name of the Home Sales member 91b exactly, the caption “Jan” was not an exact match with the January member 92b, but a mapping was still possible. For instance, the setup process 12 may have configured this mapping.

The third dimension relevant to cell D6 is the Region dimension 93, whose members appear in column B. The scanner 342 will check along row 6 to cell B6 and find a blank cell (no member). The scanner 342 will then start moving up a row at a time until it finds “North America” in cell B5. The search pattern that the scanner 342 adopts may depend on the formatting of the display spreadsheet 94a.

At this point, the scanner 342 has located a member for all dimensions; these members are used as the tuple for cell D6 in the multi-dimensional expressions list 343.

The extraction process 30 now proceeds to the consolidator 344. The multi-dimensional expressions list 343 after the completion of the RHS check 345 is shown in Table 2.

TABLE 2

| | |
|---|---|
| 1. | ([Measures].[Total Sales], [Time].[Jan], [Region].[North America]) = SUM([Measures].[Home |
| | Sales], [Measures].[Export Sales]) |
| 2. | ([Measures].[Total Sales], [Time].[Feb], [Region].[North America]) = SUM([Measures].[Home |
| | Sales], [Measures].[Export Sales]) |
| 3. | ([Measures].[Total Sales], [Time].[Mar], [Region].[North America]) = SUM([Measures].[Home |
| | Sales], [Measures].[Export Sales]) |
| 4. | ([Measures].[Profit], [Time].[Jan], [Region].[North America]) = [Measures].[Total Sales] − |
| | [Measures].[Cost] |
| 5. | ([Measures].[Profit], [Time].[Feb], [Region].[North America]) = [Measures].[Total Sales] − |
| | [Measures].[Cost] |
| 6. | ([Measures].[Profit], [Time].[Mar], [Region].[North America]) = [Measures].[Total Sales] − |
| | [Measures].[Cost] |
| 7. | ([Measures].[Total Sales], [Time].[Jan], [Region].[South America]) = SUM([Measures].[Home |
| | Sales], [Measures].[Export Sales]) |
| 8. | ([Measures].[Total Sales], [Time].[Feb], [Region].[South America]) = SUM([Measures].[Home |
| | Sales], [Measures].[Export Sales]) |
| 9. | ([Measures].[Total Sales], [Time].[Mar], [Region].[South America]) = SUM([Measures].[Home |
| | Sales], [Measures].[Export Sales]) |
| 10. | ([Measures].[Profit], [Time].[Jan], [Region].[South America]) = [Measures].[Total Sales] − |
| | [Measures].[Cost] |
| 11. | ([Measures].[Profit], [Time].[Feb], [Region].[South America]) = [Measures].[Total Sales] − |
| | [Measures].[Cost] |
| 12. | ([Measures].[Profit], [Time].[Mar], [Region].[South America]) = [Measures].[Total Sales] − |
| | [Measures].[Cost] |
| 13. | ([Measures].[Home Sales], [Time].[Jan], [Region].[Americas]) [Region].[North America] + |
| | [Region].[South America] |
| 14. | ([Measures].[Home Sales], [Time].[Feb], [Region].[Americas]) [Region].[North America] + |
| | [Region].[South America] |
| 15. | ([Measures].[Home Sales], [Time].[Mar], [Region].[Americas]) = [Region].[North America] + |
| | [Region].[South America] |
| 16. | ([Measures].[Export Sales], [Time].[Jan], [Region].[Americas]) = [Region].[North America] + |
| | [Region].[South America] |
| 17. | ([Measures].[Export Sales], [Time].[Feb], [Region].[Americas]) = [Region].[North America] + |
| | [Region].[South America] |
| 18. | ([Measures].[Export Sales], [Time].[Mar], [Region].[Americas]) = [Region].[North America] + |
| | [Region].[South America] |
| 19. | ([Measures].[Total Sales], [Time].[Jan], [Region].[Americas]) = [Region].[North America] + |
| | [Region].[South America] |
| 20. | ([Measures].[Total Sales], [Time].[Feb], [Region].[Americas]) [Region].[North America] + |
| | [Region].[South America] |
| 21. | ([Measures].[Total Sales], [Time].[Mar], [Region].[Americas]) = [Region].[North America] + |
| | [Region].[South America] |
| 22. | ([Measures].[Cost], [Time].[Jan], [Region].[Americas]) = [Region].[North America] + |
| | [Region].[South America] |
| 23. | ([Measures].[Cost], [Time].[Feb], [Region]. [Americas]) = [Region].[North America] + |
| | [Region].[South America] |
| 24. | ([Measures].[Cost], [Time].[Mar], [Region].[Americas]) = [Region].[North America] + |
| | [Region].[South America] |
| 25. | ([Measures].[Profit], [Time].[Jan], [Region].[Americas]) = [Region].[North America] + |
| | [Region].[South America] |
| 26. | ([Measures].[Profit], [Time].[Feb], [Region].[Americas]) = [Region].[North America] + |
| | [Region].[South America] |
| 27. | ([Measures].[Profit], [Time].[Mar], [Region].[Americas]) = [Region].[North America] + |
| | [Region].[South America] |

In this example, the RHS check 345 found unnecessary members among RHS tuples of every expression in the multi-dimensional expressions list 343. For instance, the first expression was:

([Measures]. [Total Sales], [Time].[Jan], [Region].[North America])=SUM( ([Measures].[Home Sales], [Time]. [Jan], [Region].[North America]), ([Measures].[Export Sales], [Time].[Jan], [Region].[North America]))

The members [Time]. [Jan] and [Region]. [North America] appear in every tuple in the expression, so they are culled from the RHS to yield the expression shown in Table 2.

The consolidator 344 now invokes the LHS check 541. This groups the multi-dimensional expressions list 343 into groups having identical right-hand sides, then applies a multi-part test (the LHS consolidator function 347) to determine whether the group can be replaced by more broadly-scoped expression. For instance, with reference to Table 2, expressions 1-3 and 7-9 all have the RHS value:

SUM([Measures].[Home Sales], [Measures].[Export Sales])

Furthermore, expressions 1-3 cite all members of the Time dimension 92a on their LHS: namely, the January member 92b, the February member 92c, and the March member 92d. This causes step 562 to flag expressions 1-3 for consolidation into one expression:

([Measures].[Total Sales], [Region].[North America])=SUM([Measures].[Home Sales], [Measures].[Export Sales])

Likewise, expressions 7-9 would be consolidated, as well:

([Measures].[Total Sales], [Region].[South America])=SUM([Measures].[Home Sales], [Measures].[Export Sales])

But, still more consolidation is possible. The LHS check 541 can also detect that the two newly-produced expressions still share the same RHS, and furthermore that the expressions contain all the descendants of the Americas member 933. Therefore step 566 will flag the expressions for consolidation into one final expression:

[Measures].[Total Sales]=SUM([Measures].[Home Sales], [Measures].[Export Sales])

Indeed, the eventual result of the LHS check 541 iterations is that the twenty-seven expressions in the multi-dimensional expressions list 343 reduce to three, as shown in Table 3.

TABLE 3

| | |
|---|---|
| 1. | [Measures].[Profit] = [Measures].[Total Sales] − [Measures].[Cost] |
| 2. | [Measures].[Total Sales] = SUM([Measures].[Home Sales], [Measures].[Export Sales]) |
| 3. | [Region].[Americas] = [Region].[North America] + [Region].[South America] |

The extraction process 30 next moves to the validater 346, to check that the input expressions contain the same dimensions on both sides of the equation. For this example, the expressions pass the test, so the extraction process 30 moves on the ranker 348. Note that expression 1 of Table 3 references the Total Sales member 91d, but that expression is a derived expression defined in expression 2 of Table 3. The ranker 348 compensates by re-ordering the multi-dimensional expressions list 343 to produce the result shown in Table 4.

TABLE 4

| | |
|---|---|
| 1. | [Measures].[Total Sales] = SUM([Measures].[Home Sales], [Measures].[Export Sales]) |
| 2. | [Measures].[Profit] = [Measures].[Total Sales] − [Measures].[Cost] |
| 3. | [Region].[Americas] = [Region].[North America] + [Region].[South America] |

Lastly, each expression in the multi-dimensional expressions list 343 is transformed into a full MDX statement that is applied to the cube 60.

Alternate Embodiments

A number of embodiments of the invention have been described. Nevertheless, it will be understood that various modifications may be made without departing from the spirit and scope of the invention.

For example, FIG. 1C shows an embodiment in which the extraction process 30 is available via a wizard process 24 within the spreadsheet application 22. The wizard process 24 includes a dialog that manages a structured sequence of user interactions with predetermined tasks, namely, the steps of the extraction process 30 as disclosed above.

In a further embodiment, FIG. 1D shows the spreadsheet application 22 having a spreadsheet add-in facility 224 which includes the wizard process 24. A spreadsheet add-in is a software program configured to install into the spreadsheet application 22 such that the spreadsheet add-in acts as an extension of the features of the spreadsheet application 22. Such features include the user interface as well as programming interfaces which the spreadsheet add-in facility 224 exposes to the wizard process 24 via a user interface API 226 and a programming API 228, respectively. The user interface API 226 allows the wizard process 24 to create and control user interface elements, including sheets, menus, and dialogs, within the spreadsheet application 22. The programming API 228 gives the wizard process 24 access to programming interfaces such as externally manipulable methods and properties of the spreadsheet application 22 itself. The spreadsheet add-in facility 224 for a given spreadsheet application 22 is known in the art; technology and techniques are usually published by the software company that manufactures the spreadsheet application 22.

An alternate embodiment of the extraction process 30 could replace the input of the user with a pre-configured set of inputs, for example a batch file containing parameters that the extraction process 30 could read. Yet another embodiment could replace the user with a computer-based algorithm which, while not pre-configured with individual responses, could use heuristics tuned to certain performance goals to provide dynamic input to the extraction process 30. For instance, an automated computer process might be configured to search a network of file servers, dynamically discovering spreadsheet collections 26 against which to apply the extraction process 30. Accordingly, in alternative embodiments of the extraction process 30, the “user” need not be a human but could be any source capable of providing input to the extraction process 30.

Alternate embodiments may also include the following. Other spreadsheet applications than Microsoft Excel may be used. Instead of Microsoft Access, the cube storage 62 may be Microsoft SQL Server, or Oracle Enterprise Server, or comparable databases that store multidimensional data. Data definition languages and data manipulation language other than MDX are possible, according to the database used to provide cube storage 62. The operating system 631 may be Apple MacOS, a handheld device OS, or any OS that can provide a spreadsheet application 22 and appropriate services. Accordingly, other embodiments are within the scope of the following claims.

What is claimed is:

1. A computer-based method for extracting multi-dimensional data from a spreadsheet, the method comprising:
providing a multi-dimensional data storage having a cube data definition language;
providing the spreadsheet in a spreadsheet application having a language for spreadsheet expressions, the spreadsheet expressions describing calculation relationships among data entities in the spreadsheet application, the spreadsheet containing a plurality of spreadsheet expressions;
parsing the plurality of spreadsheet expressions;
transforming the set of spreadsheet expressions into a set of cube expressions for defining a set of cube entities, the cube entities including dimensions, the cube expressions conforming to the cube data definition language, such that each spreadsheet expression corresponds to a cube expression and the calculation relationships among data entities in the spreadsheet application are transformed into corresponding calculation relationships among the cube entities; and
causing the set of spreadsheet expressions to create the corresponding calculation relationships within the multi-dimensional data storage.

2. The method of claim 1, wherein the parsing step includes:
parsing the plurality of spreadsheet calculation expressions into a set of spreadsheet fact expressions and a set of spreadsheet derivative expressions;
wherein the transforming step includes:
transforming the set of spreadsheet fact expressions into a set of cube fact expressions defining a set of cube fact entities, the cube fact expressions being expressions within the cube data definition language, such that each spreadsheet fact expression corresponds to a cube fact expression; and
transforming the set of spreadsheet derivative expressions into a set of cube derivative expressions defining a set of cube derivative entities, the cube derivative expressions being expressions within the cube data definition language;
and wherein the submitting step includes:
submitting the set of spreadsheet fact expressions to the multi-dimensional data storage to create the set of cube fact entities; and
submitting the set of spreadsheet derivative expressions to the multi-dimensional data storage to create the set of cube derivative entities.

3. The method of claim 2, wherein the method further comprises the steps of:
moving data from the spreadsheet fact expressions into the corresponding cube fact entities, using the correspondence defined during the step of transforming the set of spreadsheet fact expressions.

4. The method of claim 1,
wherein the multi-dimensional data storage includes a set of cube fact entities;
wherein the parsing includes:
parsing the plurality of spreadsheet calculation expressions into a set of spreadsheet fact expressions and a set of spreadsheet derivative expressions, the set of spreadsheet derivative expressions possibly being empty;
wherein the transforming includes:
transforming the set of spreadsheet derivative expressions into a set of cube derivative expressions defining a set of cube derivative entities, the cube derivative expressions being expressions within the cube data definition language;
and wherein the submitting includes:
submitting the set of spreadsheet derivative expressions to the multi-dimensional data storage to create the set of cube derivative entities.

5. The method of claim 4, wherein the method further comprises the step of:
moving data from the spreadsheet fact expressions into the corresponding cube fact entities, using the correspondence defined during the step of transforming the set of spreadsheet fact expressions.

6. The method of claim 1, wherein the transforming includes:
consolidating the set of cube expressions into a consolidated set of cube expressions having equivalent collective scope, equivalent calculation behavior, and fewer expressions than contained in the set of cube expressions before consolidation.

7. The method of claim 1, wherein an interactive dialog wizard provides at least part of the user's interaction with the method.

8. The method of claim 1, wherein the method is implemented as an add-in to a spreadsheet application.

9. A computer apparatus for extracting multi-dimensional data from a spreadsheet, the apparatus comprising:
a central processing unit, random-access memory, a storage device, and devices for user input and output interconnected by a bus, together with computer-readable instructions capable of causing the processing unit to perform the steps of:
providing a multi-dimensional data storage having a cube data definition language;
providing the spreadsheet in a spreadsheet application having a language for spreadsheet expressions, the spreadsheet expressions describing calculation relationships among data entities in the spreadsheet application, the spreadsheet containing a plurality of spreadsheet expressions;
parsing the plurality of spreadsheet expressions;
transforming the set of spreadsheet expressions into a set of cube expressions for defining a set of cube entities, the cube entities including dimensions, levels, and members, the cube expressions conforming to the cube data definition language, such that each spreadsheet expression corresponds to a cube expression and the calculation relationships among data entities in the spreadsheet application are transformed into corresponding calculation relationships among the cube entities;
causing the set of spreadsheet expressions to create the corresponding calculation relationships within the multi-dimensional data storage; and
moving fact data from the spreadsheet expressions into the corresponding cube entities, using the correspondence defined during the step of transforming the set of spreadsheet expressions.
